(19) United States
(12) Patent Application Publication
(10) Pub. No.: US 2021/0161108 A1
(43) Pub. Date: Jun. 3, 2021

(54) LAND-BASED FISH REARING PLANT

(71) Applicant: NORDIC AQUAFARMS AS, Gamle Fredrikstad (NO)

(72) Inventors: Simen HAALAND, Fredrikstad (NO); Ketil FJELD, Gamle Fredrikstad (NO); Erik HEIM, Hosle (NO)

(73) Assignee: NORDIC AQUAFARMS AS, Gamle Fredrikstad (NO)

(21) Appl. No.: 17/046,720

(22) PCT Filed: Apr. 9, 2019
(86) PCT No.: PCT/NO2019/050075

§ 371 Date: Oct. 9, 2020

(30) Foreign Application Priority Data
Apr. 9, 2018 (NO) 20180482

(51) Int. Cl. A01K 61/10; A01K 61/95

(52) U.S. Cl. CPC A01K 61/10; A01K 63/04; A01K 61/95

(57) ABSTRACT

A land-based fish rearing plant includes a postsmolt unit with the following features: an oval flow tank for postsmolt, subdivided for postsmolt cohorts of successively increasing sizes, at flow generator for providing a main flow, water outlets for a partial flow from the oval flow tank to a water treatment plant wherein said water treatment plant is arranged within the perimeter of an inner wall of said flow tank, at least two grow-out units for growing salmon in the stages after the postsmolt stages, each grow-out unit including: an oval flow tank for said growing salmon, subdivided into tank sections for growing salmon cohorts of successively increasing sizes, a main flow generator for providing a main flow, water outlets for a partial flow from the oval flow tank to a water treatment plant including and a water return inlet to said flow tank, wherein said water treatment plant is arranged within the perimeter of an inner wall of said flow tank a purge-unit including, arranged between said grow-out units, wherein the last sections in said grow-out units are connected via lock-gates to an inlet channel to two or more purge chambers for temporary holding and purging of the salmon prior to its slaughtering, wherein the purge-unit includes at least a water treatment plant and an export line to a fish slaughterhouse.

### FIELD OF THE INVENTION

The present invention relates to the technical field of land-based fish rearing plants. More specifically, in a broad sense, the invention comprises two large units (B, C) comprising oval main flow tanks (B, C) for grow-out fish, each with their own dedicated water treatment plants (4B, 4C) generally entirely arranged within the perimeter of the inner wall of the flow tanks, and a purge plant (12) arranged in between the oval flow tanks (B, C). Even more specifically, the invention comprises a postsmolt tank (A) also having its water treatment plant (4A) generally entirely arranged within the perimeter of the inner wall of the flow tank (1A) and arranged for feeding postsmolt large enough for transfer to the grow-out tanks.

### BACKGROUND ART

WO 2014/183765 depicts a fish farming plant comprising a central tank and one or more surrounding tanks wherein the central tank is used for water treatment, and the one or more surrounding tanks are used for farming of fish, further comprising flow applicators, whereby the flow rate of the water in the surrounding tanks are individually independent of the water exchange rate, wherein the fish farming plant comprises several movable permeable section walls in each of the surrounding tanks dividing said tanks in tanks sections, each surrounding tank is equipped with one or two outlets and one or two inlets a, and a substantially horizontal/laminar flow structure of the water in each one of said one or more surrounding tanks is provided.

### SHORT SUMMARY OF THE INVENTION

The current invention is a land-based fish rearing plant comprising:

A land-based fish rearing plant comprising:
a postsmolt unit (A) comprising:
   an oval postsmolt flow tank (1A) subdivided by a number (n) of transverse separation grids (2A1 to 2An) into the number of (n) tank sections (3A1 to 3An) for postsmolt cohorts of successively increasing sizes,
   one or more main flow generators (9A) for providing a main flow (ΦAmain) along a main flow path in said oval postsmolt flow tank (1A),
   one or more water outlets (7A) for a partial flow from said oval postsmolt flow tank (1A) to a first water treatment flow (ΦA_{RAS}) in a first water treatment plant (4A) comprising piping arrangement (5A) and pumps (6A) and one or more direct water return inlets (8A) to said postsmolt flow tank (1A),
   wherein said water treatment plant (4A) is arranged within a perimeter of an inner wall (10Ai) of said postsmolt flow tank (1A),
at least two grow-out units (B, C) for growing salmon in the stages after said postsmolt stages, each grow-out unit (B, C) comprising:
   an oval grow-out flow tank (1B, 1C) for said growing salmon, subdivided by a number (m) of transverse separation grids (2B1 to 2Bm, 2C1 to 2Cm) into the number of (m) tank sections (3B1 to 3Bm, 3C1 to 3Cm) for growing salmon cohorts of successively increasing sizes,
   one or more main flow generators (9B, 9C) for providing a main flow (ΦBmain, ΦCmain) along a main flow path in said oval grow-out flow tanks (1B, 1C), respectively
one or more water outlets (7B, 7C) for a partial flow from said oval grow-out flow tanks (1B, 1C) to second and third water treatment flows (ΦB_{RAS}, ΦC_{RAS}) in second and third water treatment plants (4B, 4C) each comprising piping arrangements (5B, 5C) and pumps (6B, 6C) and one or more water return inlets (8B, 8C) to said grow-out flow tanks (1B, 1C), respectively, and
   wherein said second and third water treatment plants (4B, 4C) are arranged within a perimeter of an inner wall (10Bi, 10Ci) of said grow-out flow tanks (1B, 1C), respectively
a purge-unit (12) arranged between said grow-out units (B, C), wherein the last sections (m) in said grow-out units (B, C) are connected via lock-gates (14B, 14C) to an inlet channel (15) to two or more purge chambers (13a, 13b, . . . 13z) for temporary holding and purging of the salmon prior to its slaughtering, wherein said purge-unit (12) comprises a fourth water treatment plant (16) and an export line (171) to a fish slaughterhouse (17).

In an embodiment of the invention is also a method for fish farming in a fish rearing plant:

A method for fish farming in a land-based fish rearing plant comprising:
providing an oval postsmolt flow tank (1A) and two grow-out flow tanks (1B, 1C);
running flow generators (9A, 9B, 9C) to set up main flows in said flow tanks (1A, 1B, 1C) respectively,
running and maintaining a cleaning water and pumps (6A, 6B, 6C) in central water treatment plants (4A, 4B, 4C) arranged within inner perimeters of said flow tanks (1A, 1B, 1C);
having said sections (3A1-3An) of said postsmolt tank (1A) occupied with postsmolt and said sections (3B1-3Bm) and (3C1-3Cm) of said grow-out tanks (1B, 1C) occupied with grow-out salmon,
at given time intervals:
transferring a largest cohort of grow-out salmon alternately from one section (3Bm, 3Cm) of one of said grow-out tanks (1B, 1C) to an inlet channel (15) of one of said purge chambers (13a, 13b, . . . 13z) for temporary holding and purging of the salmon,
for each tank section prior to said alternately grow-out salmon emptied tank section (3Bm, 3Cm) all the way down to said first section (3B1, 3C1), moving each said grow-out salmon cohort to a subsequent tank section,
moving/transferring a largest cohort of postsmolt over from a last section (3An) of said postsmolt tank (1A) over to at least one of said first sections (3B1, 3C1) in said grow-out flow tanks (3B, 3C),
for each tank section prior to section (3An) of said postsmolt tank (1A) all the way down to said first section (3A1), moving each postsmolt cohort to a subsequent tank section,
supplying a new postsmolt cohort to said first tank section (3A1) of said postsmolt tank (1A).

### FIGURE CAPTIONS

The attached figures illustrate some embodiments of the claimed invention.

FIG. 1 illustrates the invention comprising a postsmolt unit (A), two grow-out units (B and C) and a purge unit (12). The flow directions in the postsmolt tank and the grow-out tanks (1A, 1B, 1C) are the same. Final sections (3B5, 3C5) “end up” at an exit line (16) to purge unit (12). Postsmolt is pumped from a final section (3A9) of the postsmolt flow tank (1A) to first sections (3B1, 3C1) of the grow-out flow tanks (1B, 1C).

FIG. 2 illustrates an embodiment of the invention and is a perspective view of one of the postsmolt units A or the grow-out units B, C with a main flow postsmolt and grow-out flow tanks (1A, 1B, 1C), respectively, and a water first, second and third water treatment plant (4A, 4B, 4C) arranged entirely within the perimeter of the inner wall of the main flow tanks, respectively.

FIG. 3 illustrates an embodiment of the invention and is a plane view of one of the postsmolt unit (A) or the grow-out units (B or C), with the main flow postsmolt and grow-out flow tanks (1A, 1B, 1C) and each water treatment plant (4A, 4B, 4C) arranged within the perimeter of the inner wall of the main flow postsmolt and grow-out flow tanks (1A, 1B, 1C), and shows major features such as the filter units (41A), biofilm reactors (42A), degassing units (43A), main flow generators (9A, 9B, 9C) arranged in the main postsmolt and grow-out flow tanks (1A, 1B, 1C), respectively, and water outlets (7A, 7B, 7C) arranged in transverse rows across the main flow at the bottom of the main flow tanks. The return inlets (8A, 8B, 8C) from the water treatment plants are not detailed here.

FIG. 4 illustrates an embodiment of the invention and is a cross sectional view of one of the postsmolt unit (A) or the grow-out tanks (B or C), with the main flow postsmolt or grow-out flow tank (1A, 1B, 1C) and the water treatment plant (4A, 4B, 4C) within the perimeter of the inner wall of the main flow tank, respectively, and shows major features such as the filter units (41A (41B, 41C)), biofilm reactors (42A (42B, 42C)), degassing units with CO2 removal (43A (43B, 43C)), water treatment flow pumps (6A (6B, 6C)), outlets (7A (7B, 7C)) from the flow tank, with transversal channels (71A (71B, 71C)) and return inlets (8A (8B, 8C)) to the flow tank, with transversal channels (81A (81B, 81C)). The different water levels are depicted in the cross-sectional view showing successively the tank water level, drum filter water level, biofilm reactor water level and degassing unit water level with CO2 removal.

FIG. 5 illustrates an embodiment of the invention similar to FIG. 3 but where the main flow generators (9A, 9B, 9C) are placed outside their respective postsmolt and grow-out flow tanks (1A, 1B, 1C) and having continuously, incrementally moving grids and sections (3A1-3A9, 3B1-3B5, and 3C1-3C5) while moving each cohort with each section. In an embodiment of the invention there are arranged motors (18A1, 18B1, 18C1) connected to vertical shafts (19) on grids (2A1-2An, 2B1, 2BM, 2C1, 2Cm) to pinion (20) to mesh with rack (21A, 21B, 21C). The grids may be moved with different speeds in order to adjust section volume with cohort weight.

FIG. 6 illustrates the same embodiment as in FIG. 4 with motors (18A1, 18B1, 18C1) connected to vertical shafts (19) on grids (2A1-2Cm) to pinion (20) to mesh with rack (21B, 21B, 21C).

FIG. 7 illustrates the purge tank (12) with its system to service two grow-out tanks (1B and 1C). Fish that are ready to be slaughtered are transferred from the main grow-out tanks (1B, 1C) into purge chambers (13a, 13b, . . . ) through transfer gates between the tanks. Joint walls with the tanks (B and C) gives construction savings.

FIG. 8 illustrates an embodiment of the invention with external flow generators (9A, 9B, 9C) located within a flow channel (92A, 92B, 92C) with a grid (97A, 97B, 97C), main flow outlets (91Ao, 91Bo, 91Co) and return inlets (91Ai, 91Bi, 91Ci).

FIG. 9 illustrates the method of transfer (shown as a matrix) within the postsmolt flow tank (1A) sections (3A1 to 3A9) and the transferal of the largest cohort of postsmolt over from a last section (3An) in postsmolt tank (1A) over to at least one of the first sections (3B1, 3C1) in the grow-out flow tanks (3B, 3C), and further on to the purge tank (12).

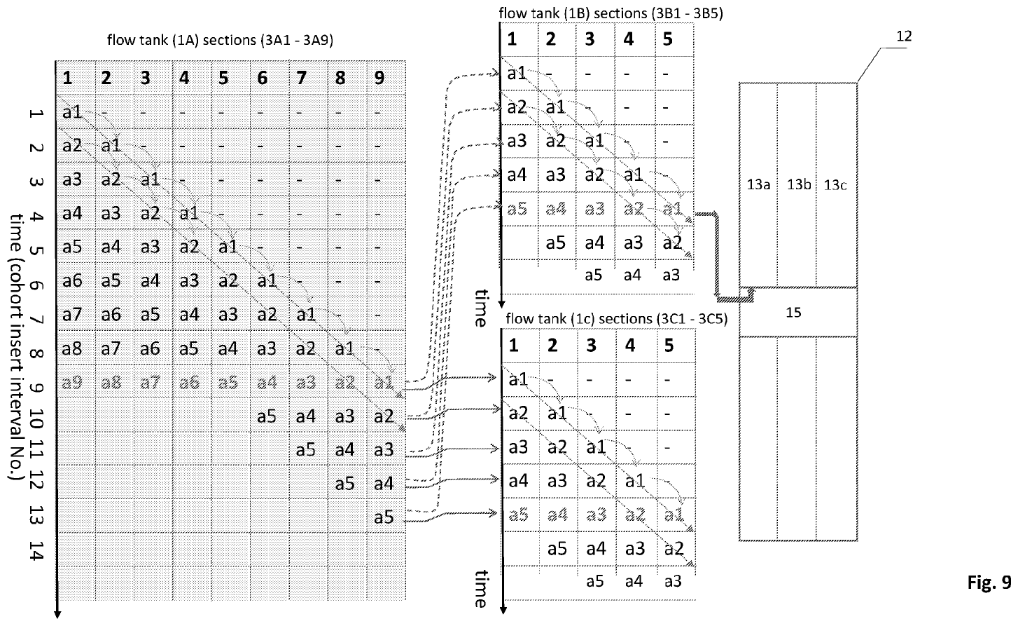

### EMBODIMENTS OF THE INVENTION

The invention will in the following be described and embodiments of the invention will be explained with reference to the accompanying drawings.

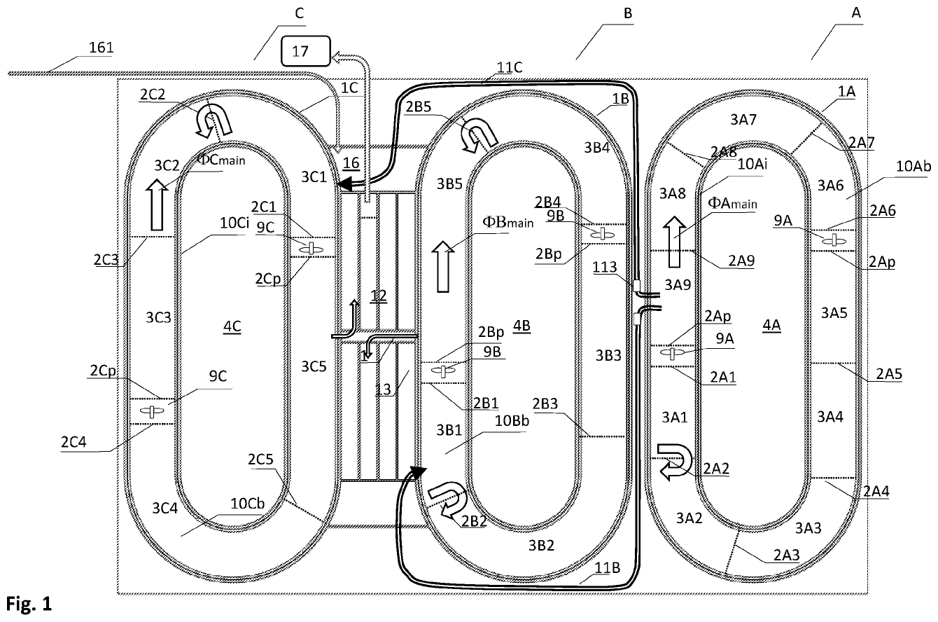

The invention is a land-based fish rearing plant. The invention comprises two or more grow-out units (B, C) for rearing of the fish cohort's stages after the postsmolt stage, and a purge unit (12) arranged common to the grow-out units (B, C). Grown-out fish at about 4.2 kg is exported from the purge unit (12). The postsmolt is imported from a separate producer of smolt, or smolt is reared locally. The grow-out units (B, C) may be arranged transversely in a series of two, with the purge unit (12) placed between the grow-out units (B) and (C). The materially largest component of each unit is an oval grow-out flow tank (1B, 1C). Please see FIG. 1 for the general overview. For forming an overview, the illustrated embodiment's grow-out flow tanks (1B, 1C) each have a longside length of 45 metres, an overall length of 80.4 metres, a total width of 35.4 metres, and a height of 6.5 metres and a water depth of 6 metres. The width of each “raceway”, the main flow channel in the grow-out tank (1B, 1C) is 8.2 metres. Thus, the contained water volume in each raceway, the grow-out tank (1B) or (1C) alone is about 9200 m3. Additionally, the centrally arranged water treatment plant (4B, 4C) of each unit (B, C) holds considerable amounts of water. Specific measures are given in the table below. Please notice that the embodiments described here are dimensioned for salmon post-smolt and grow-out cohorts, but with minor modifications could be adapted to other species such as trout, yellowtail kingfish, mahi mahi, grouper fish and others.

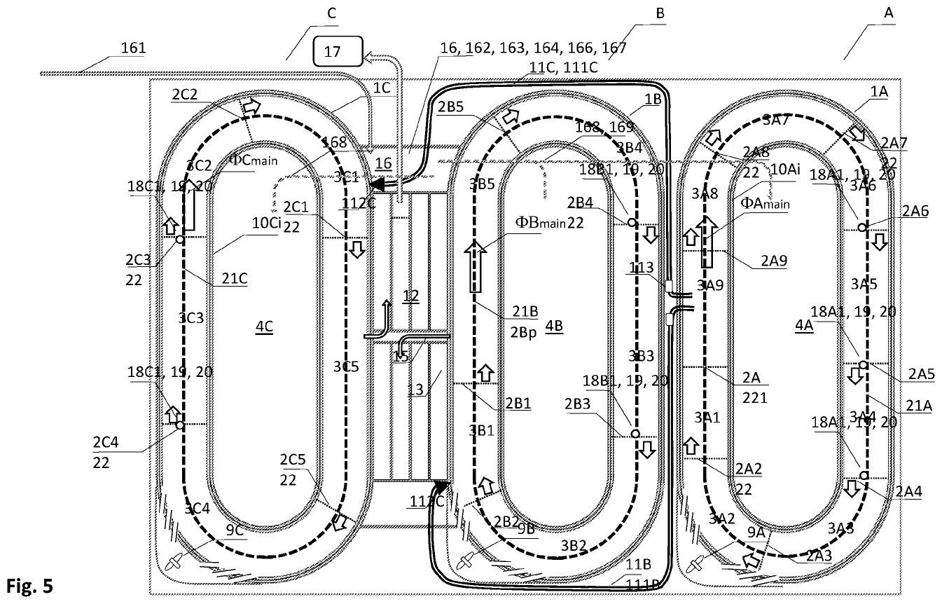

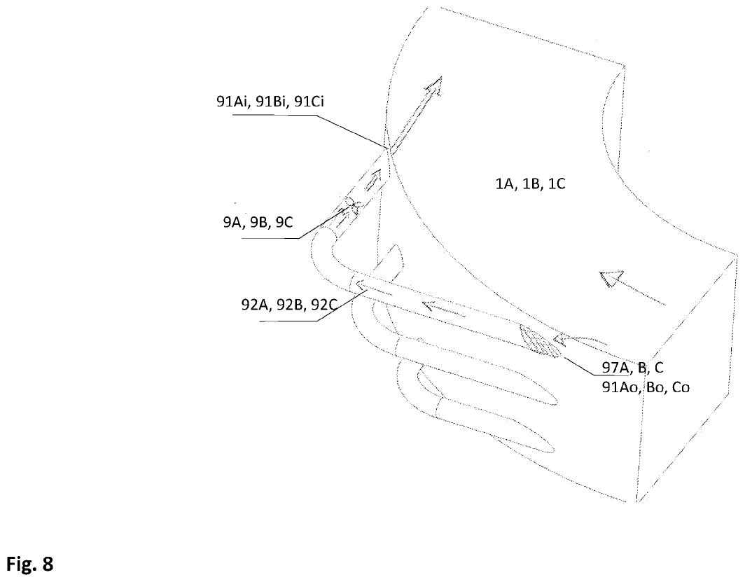

In an embodiment of the invention there is arranged a postsmolt unit (A) for rearing of the postsmolt fish cohorts. The postsmolt unit (A) comprises:
Firstly, it has an oval postsmolt flow tank (1A) for postsmolt, subdivided by a number (n) of transverse separation grids (2A1 to 2An) and thus subdivided into the number (n) tank sections (3A1 to 3An) for postsmolt cohorts of successively increasing sizes. In the illustrated embodiment there are nine tank sections. If inserted once a month, each cohort of postsmolt will reside nine months in the oval postsmolt flow tank (1A) while growing. Please observe that if the below mentioned flow generators (9A) are placed in the main flow, additional grids (2Ap) must be arranged in order to prevent fish from being damaged or turbulence-affected by the flow generators, while if the flow generators is placed outside the postsmolt flow tank, please see FIG. 5 and FIG. 8, there is no need for such an additional grid (1Ap). The same relates to the grow-out tanks (1B, 1C).
Secondly, it has one or more main flow generators (9A) for providing a main flow (ΦAmain) along a main flow path in the oval grow-out flow tank (1A).
Thirdly, it has one or more water outlets (7A) for a partial flow from the oval grow-out flow tank (1A) to a first water treatment flow (ΦA_{RAS}) through a first water treatment plant (4A) comprising piping arrangement (5A) and pumps (6A) and having one or more water return inlets (8A) to said postsmolt flow tank (1A).
Fourthly, the first water treatment plant (4A) is arranged within the perimeter of an inner wall (10Ai) of said postsmolt flow tank (1A). Having generally the entire first water treatment plant (4A) in the middle oval within the perimeter of the inner wall of the postsmolt flow tank (1A) is highly advantageous due to the fact that piping and channels between the oval postsmolt flow tank (1A) and the first water treatment plant (4A) becomes short, thus requiring significantly less pumping energy and construction and material costs, surface cleaning, disinfection and maintenance costs compared to external water treatment plants. Prior art tanks having a water treatment plant subdivided into a internal and an external part relative to the raceway, such as having a particle filter and biofilter plant internal and a degassing plant external, would require much transport of water back and forth through passages below or above across the flow tank.
In the postsmolt unit (A) postsmolt flow tank (1A) we will insert smolt cohorts, e.g. at intervals of one month, initially at the size of about 100 g, and rear in in the sections (3A1 to 3An) up to a weight of about 1900 g.

In an embodiment of the invention, the largest cohort of the postsmolt tank (1A) will be split into two (preferably) fractions and each fraction of the cohort will be moved over to the two grow-out flow tanks (1B, 1C). There may be further grow-out units (B, C) than two, but we have come to the conclusion that having two such grow-out units per one postsmolt unit is advantageous because the rather large purge unit (12) which shall serve both, is placed immediately between the grow-out units (B, C), please see FIGS. 1, 5, 5, and 7.

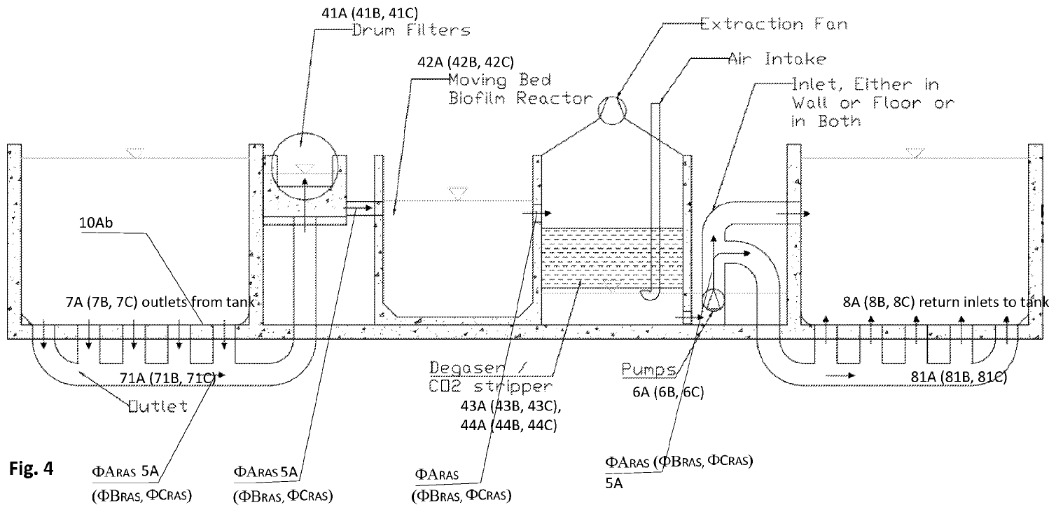

Each of the two grow-out units (B, C) for growing salmon in the stages after the postsmolt stages comprises:
Firstly, an oval grow-out flow tank (1B, 1C) for said growing salmon. Each oval flow tank (1B, 1C) is subdivided by a number (m) of transverse separation grids (2B1 to 2Bm, 2C1 to 2Cm) and thus subdivided into the number (m) tank sections (3B1 to 3Bm, 3C1 to 3Cm) for growing salmon cohorts of successively increasing sizes.
Secondly, each grow-out unit (B, C) has one or more main flow generators (9B, 9C) for providing a main flow (ΦBmain, ΦCmain) along a main flow path in said oval grow-out flow tank (1B, 1C),
Thirdly, each grow-out flow tank (1B, 1C) has one or more water outlets (7B, 7C) for a partial flow from the oval grow-out flow tank (1B, 1C) to form water treatment flows (ΦB_{RAS}) (ΦC_{RAS}) a in the second and third water treatment plants (4B, 4C). The water treatment plants comprise piping arrangement (5B, 5C) and pumps (6B, 6C) and at least one water return inlet (8B, 8C) to the grow-out flow tanks (1B, 1C), please see FIG. 4.
Fourthly, the second and third water treatment plants (4B, 4C) is arranged within the perimeter of an inner wall (10Bi, 10Ci) of said grow-out flow tanks (1B, 1C), respectively, just as for the first water treatment plant (4A) in the postsmolt unit (A). Having generally the entire water treatment plant (4A, 4B) in the middle oval within the perimeter of the inner wall of the grow-out flow tank (1B, 1C) is highly advantageous just as mentioned for the post-smolt unit (1A) above.

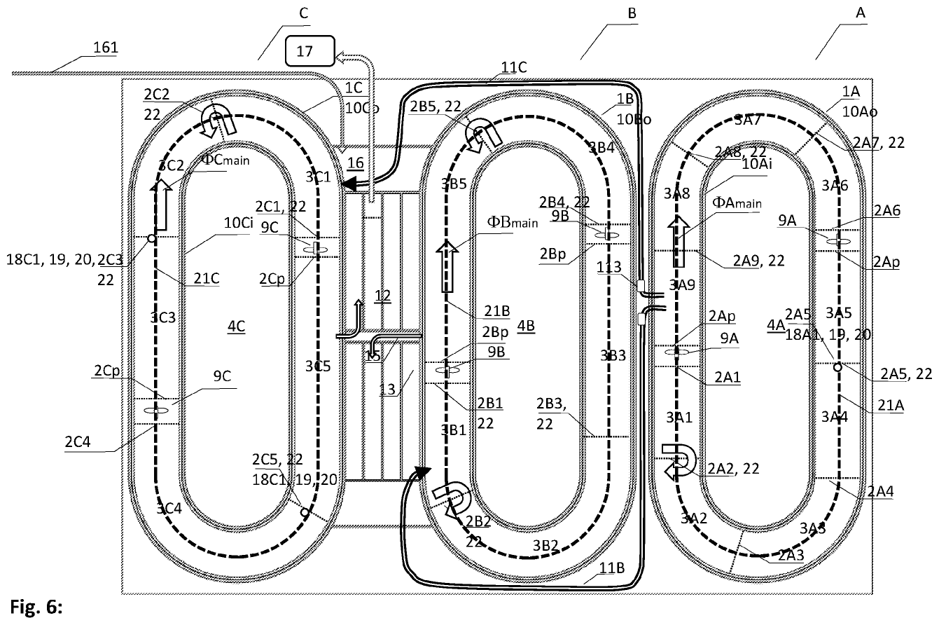

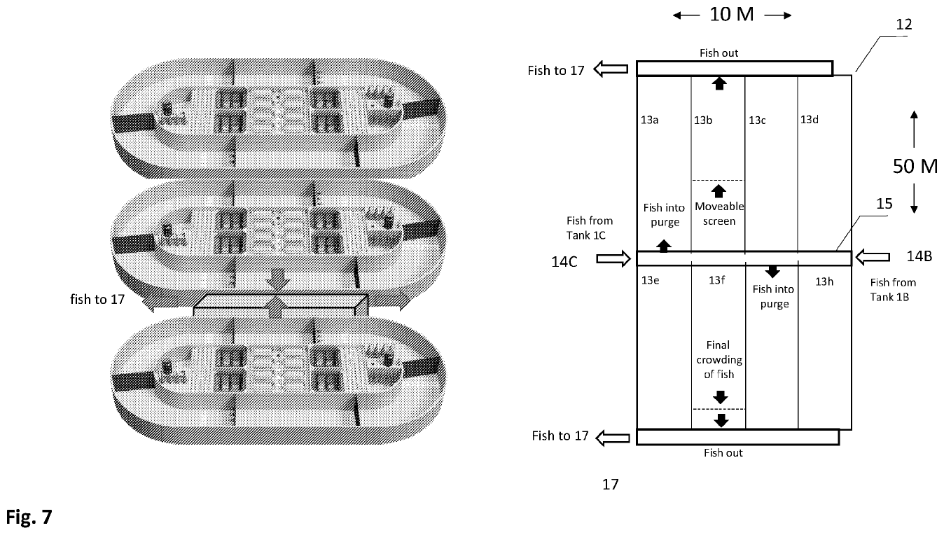

A purge-unit (12) is arranged between said grow-out units (B, C), wherein the last sections (m) in said grow-out flow tanks (1B, 1C) of grow-out units (B, C), respectively are connected via lock-gates (14B, 14C) to an inlet channel (15) to two or more purge chambers (13a, 13b, . . . 13z) for temporary holding and purging of the grown-out salmon cohorts prior to its slaughtering, wherein the purge-unit (12) comprises at least a fourth water treatment plant (16) and an export line to a fish slaughterhouse (17). In a preferred embodiment of the invention the number of purge chambers is 8, please see FIG. 5, FIG. 6, and FIG. 7.

The invention is a land-based fish rearing plant. The more narrowly defined invention comprises a postsmolt unit (A) for rearing of the postsmolt fish cohorts, two or more grow-out units (B, C) for rearing of the fish cohort's stages after the postsmolt stages, and a purge unit (12) arranged common to the grow-out units (B, C). Grown-out fish at about 4.2 kg is exported from the purge unit (12). The postsmolt is imported from a separate producer of smolt, or smolt is reared locally. The units (A, B, C) may be arranged transversely in a series of three, with the purge unit (12) placed between units (B) and (C). The materially largest component of each unit is an oval flow tank (1A, 1B, 1C) which are a postsmolt flow tank (1A), and two grow-out flow tanks (1B, 1C). Please see FIG. 1 for the general overview. For forming an overview, the illustrated embodiment's flow tanks (1A, 1B, 1C) each have a longside length of 45 metres, an overall length of 80.4 metres, a total width of 35.4 metres, and a height of 6.5 metres and a water depth of 6 metres. The width of each “raceway” is 8.2 metres. Thus, the contained water volume in the raceway alone is about 9200 m3. Additionally, the centrally arranged first, second and third water treatment plant (4A, 4B, 4C) of each unit (A, B, C), respectively, holds considerable amounts of water. Specific measures are given in the table below. Please notice that the embodiments described here are dimensioned for salmon post-smolt and grow-out cohorts, but with minor modifications could be adapted to other species such as trout, yellowtail kingfish, mahi mahi, grouper fish and others.

| | | |
|---|---|---|
| Length of longside | 45 | m |
| Raceway width of postsmolt flow tank and | 8.2 | m |
| grow-out flow tank | | |
| Height of wall | 6.5 | m |
| Wall thickness | 0.5 | m |
| Water depth in raceway | 6 | m |
| Inner diameter of raceway, i.e. wet surface | 18 | m |
| of inner wall (10Ai) | | |
| Overall raceway length of postsmolt and | 80.4 | m |
| grow-out flow tank (1A, 1B, 1C) | | |
| Overall width of flow tank | 35.4 | m |
| Total flow tank volume | 9184 | m³ |
| Floor tank bottom (10Ab, 10Bb, 10Cb) area | 1413 | m² |
| Wall area in flow tank (1A, 1B, 1C) | 2240 | m² |
| Total surface area of tank | 3653 | m² |
| Contained water volume in flow tank | 8478 | m³ |
| Production volume (eks.propeller) if flow | 7500 | m³ |
| generators present in main flow | | |
| Hydraulic retention time in the flow tank | 30 | min |
| Water volume reserved for propeller section, | 978 | m³ |
| (if the main flow generator (9A, 9B, 9C) | | |
| propeller are placed in the main flow tank | | |
| (1A, 1B, 1C), respectively | | |
| Length of tank sections for flow generators | 19.9 | m |
| combined, if a number of two propellers/main | | |
| flow generators | | |
| Length of tank sections (3Ap, 3Bp, 3Cp) per | 9.9 | m |
| propeller | | |

In an embodiment of the invention the number of tank sections (3A1-3An) of the postsmolt flow tank (1A) are between 6 and 10. As noted above, the number of separation grids (2A1-2An) purely for separating the sections is the same number. If flow generators (9A) are arranged in the main flow, one additional grid (2Ap) is required for each flow generator in order to prevent damage to the fish. In an embodiment of the invention, please see FIG. 1, the number of tank sections (3A1-3An) in the postsmolt flow tank is 9.

In the embodiment shown in FIG. 1 the final tank sections (3B5, 3C5) of the grow-out flow tanks (1B, 1C) are facing the purge unit (12) in order for being adjacent to the channel (15) so as for making the transfer of fish feasible. In this embodiment one may say that grow-out flow tank (1C) is a copy of grow-out flow tank (1B) but rotated 180 degrees in the horizontal plane. Please also notice that in the illustrated embodiment shown in FIG. 1 the overall shape and design of grow-out tanks B and C is the same as the overall shape of postsmolt tank A.

All water outlets (7A, 7B, 7C) from the main flow of the flow tanks (1A, 1B, 1C) to the first, second and third water treatment plants (4A, 4B, 4C), respectively, must be provided with grids (77A, 77B, 77C) in order to prevent fish from entering the water treatment plants.

In an embodiment the insert postsmolt cohort is 100 grams, and each cohort is fed until it has grown to about 1900 grams in section 3An, i.e. section 3A9 after about 9 months.

In an embodiment of the invention, Oxygen supply (45A) to the water may be installed in the water first water treatment plant (4A). In another embodiment of the invention, the oxygen supply (45A) may be installed directly in the postsmolt flow tank (1A) because it advantageously could be operated by manual valves during undesired intermittent absence of electrical power. The same goes for Oxygen supply (45B, 45C) to the grow-out flow tanks (1B, 1C).

In an embodiment of the invention the first water treatment plant (4A) comprises a number of filter units (41A), a biofilm reactor (42A), a degassing unit with CO2 treatment (43A), and an Ozone treatment unit (44A). In this way, the entire water treatment flow (ΦA_{RAS}) may occur within the perimeter of the inner, oval wall of the postsmolt flow tank (1A), which advantageously thus may have a short flow path. Similar considerations are valid for the second and third water treatment plants with regard to the grow-out flow tanks (1B, 1C).

In an embodiment of the invention, there is a number of separation grids (2Bm and 3Bm) and sections (2Cm and 3Cm) in said grow-out unit's (B, C) oval flow tank (1B, 1C) between 3 and 7. In a further embodiment the number is 5. This makes the retention time for each cohort in the grow-out units to be five months if the interval between the insert cohorts is one month as above described. The cohort from the post-smolt stage is split into one half distributed to each first grow-out tank (1B, 1C) first section (3B1, 3C1) when moved. At this stage each half of the cohort are of the same size and weight unless sorted. One may sort them, but in an embodiment of the invention the temperatures in the grow-out tanks are kept different in order for the two parallel cohorts to grow differently so as for the two initially parallelly introduced cohorts to be harvested with the half interval, i.e. transferred with two weeks interval to the purge unit (12).

In an embodiment of the invention the grow-out unit's (B, C) grow-out flow tank (1B, 1C) is arranged for holding grow-out salmon in the size range 1900-4300 g.

In an embodiment of the invention the grow-out unit's (B, C) water treatment plant (4B and 4C) comprise filter units (41B, 41C), a biofilm reactor (42B, 42C), a degassing unit with CO2-removal (43B, 43C), and an Ozone treatment unit (44B, 44C), respectively.

In an embodiment of the invention the postsmolt flow tank's (1A) flow generator (9A) providing the main flow (ΦAm) is arranged in the main flow path of the oval postsmolt tank (1A). In this embodiment it may have the form of a propeller axially aligned with the main flow path along the oval tank, please see FIGS. 1, 3, and 6.

In another embodiment of the invention the postsmolt tank's (1A) flow generator (9A) providing said main flow (ΦAm) is arranged outside the flow tank (1A) as such, i.e. inside the perimeter of the inner wall (10Ai), outside the perimeter of an outer wall (10Ao), please see FIG. 5, or below the bottom (10Ab) in relation to the main flow path in said oval flowtank (1A). Please see FIG. 8 for the embodiment of the flow generator (9A) arranged outside the oval flowtank (1A). Similar arrangements may be made for each the grow-out flow tanks (1B, 1C), please see FIG. 5. In this case the water may be taken out through main flow outlets (91Ao (91Bo, 91Co)) to a flow generator (9A (9B, 9C)) such as a propeller or impeller arranged in a tunnel (92A (92B, 92C)) and a return inlet (91Ai (91Bi, 91Ci)) back to the main flow path in the flow tank (1A (1B, 1C)). In such embodiments the main flow outlets (91Ao (91Bo, 91Co)) must be provided with a grid (97A (97B, 97C)) in order to prevent fish from entering the tunnel (92A (92B, 92C)) to avoid being killed in the flow generator (9A (9B, 9C)). The number of flow generators and flow tunnels needs to be adapted and calculated for each specific application.

Advantageously said outlets and inlets (91Ao, 91Ai) are designed with low-angled inlet and outlet passages in order to minimize energy loss, please see FIG. 8 for illustration. In an embodiment of the invention the flow generators (9A) shall maintain an overall water flow velocity of 0.4 m/s for the main flow (ΦAm) for the postsmolt cohorts. We consider the embodiment as shown in FIG. 8 and explained above in this paragraph, with a flow tank (1A, 1B, 1C) with the described and illustrated flow generator (9A, 9B, 9C) arranged outside the flow tank, as an independent invention in itself.

In an embodiment of the invention, the flow generators (9B, 9C) of the oval grow-out flow tanks which provide the main flow (ΦBmain, ΦC main) are arranged in the main flow path of the oval flow tanks (1B, 1C).

By placing the flow generators (9B, 9C) in the main flow path of the oval flow tanks (1B, 1C) one can provide and optimize the flow path which in turn ensures reduced pumping and pressure loss in the system, thus reducing the total power consumption. In this embodiment it may have the form of a propeller axially aligned with the main flow path along the oval tank.

In an embodiment of the invention, the flow generators (9B, 9C) which provide the main flow (ΦBmain, ΦC main) in the grow-out flow tanks are arranged within the circumference of the inner wall (10Bi, 10Ci), or outside the circumference of the outer wall (10Bo, 10Co), please see FIG. 5, or below the bottom (10Bb, 10Cb) in relation to the main flow path of the oval flow tank (1B, 1C). Having the flow generators placed outside of and external to the oval flow tanks (1B, 1C) will reduce the potential of fish getting damaged or killed by the flow generator propellers. Also, by placing the flow generators outside of the oval flow tanks (1B, 1C) it is much simpler to produce a laminar main flow geometrically through piping and/or ducting. A laminar and uniform flow is beneficial for the fish's wellbeing and growth. In such case the water may be taken out through main flow outlets (91Bo, 91Co) to a flow generator (9B, 9C) such as a propeller or impeller arranged in at least one tunnel (92B, 92C) and at least one return inlet (91Bi, 92Ci) back to the main flow path in the grow-out flow tank (1B, 1C).

The number of flow generators and flow tunnels needs to be adapted and calculated for each specific application. In such embodiments the main flow outlets (91Bo, 91Co) must be provided with a grid (97B, 97C) in order to prevent fish from entering the tunnel (92B, 92C) to avoid being killed in the flow generator (9B, 9C).

In an embodiment of the invention, the number of the purge chambers (13a, 13b, . . . 13z) is between four and ten.

In another embodiment of the invention, the number of the purge chambers (13a, 13b, . . . 13z) is eight.

A preferred configuration will be to use six of the eight purge chambers and have two as spare, whereas the spare chambers will function as a buffer reservoir. This buffer can be beneficial if e.g. there is a price drop in the market that requires the fish farming plant to hold back a certain amount of grow-out salmon for awaiting the spot market price to rise. Another benefit to having spare capacity in the purge chamber is if there are intermittent problems or technical issues with the delivery to the fish slaughtering plant. The additional chambers will in this instance act as a buffer until the fault has been rectified with respect to the fish slaughtering plant.

In an embodiment of the invention, the water level in said postsmolt unit (A) decreases successively from the oval postsmolt flow tank (1A) to said filter unit (41A), to said biofilm reactor (42A) and further to said degassing unit with CO2 treatment (43A), please see FIG. 4.

In another embodiment of the invention, the water level in each of the oval grow-out units (B, C) decreases successively from the oval flow grow-out flow tanks (1B, 1C) to said filter units (41B, 41C), to said biofilm reactor (42B, 42C) and further to said degassing unit with CO2 treatment (43B, 43C). By utilizing a gravity flow in the water treatment section, i.e. the height differences between the oval flow tanks, the filter units, the biofilm reactor and degassing unit with CO2 treatment there is only a need for one step to pump the last portion of the treated water from the degassing unit with CO2 treatment back to the oval flow tank (1b, 1C). Thus, reducing the power consumption in the pump(s).

In an embodiment of the invention, wherein a water outlet (7A) for the water treatment flow (ΦA_{RAS}) to the first water treatment plant (4A) is arranged in the bottom (10Ab) of the oval postsmolt flow tank (1A).

Having the water outlet (7A) (an outlet as seen from the grow-out tank) for the water treatment flow arranged in the bottom of the oval flow tank (1A) is advantageous since it will be more efficient to extract debris, feces, from the main flow into the water treatment flow as these elements tend to accumulate at the bottom of the tank.

In an embodiment of the invention, the water treatment flow (ΦA_{RAS}) from the water treatment plant (4A) is pumped back to the oval flow tank (1A) via a water return inlet (8A) that is arranged through at least one or more of the inner walls (10Ai), the outer wall (10Ao) or the bottom (10Ab) of the oval flow tank (1A).

By having the option of different configurations for the water return (8A) one can tune and adjust the return flow in such a manner to reduce the back pressure and power consumption of the pump (6A).

In an embodiment of the invention, the water outlet (7A) of the water treatment flow (ΦA_{RAS}) is co-current with the main flow (ΦAmain). By having the water outlet (7A) co-current with the main flow one is able to reduce the pressure loss in the water treatment flow.

In an embodiment of the invention, the water outlet (7A) forms an angle of 30 degrees with the bottom (10Ab).

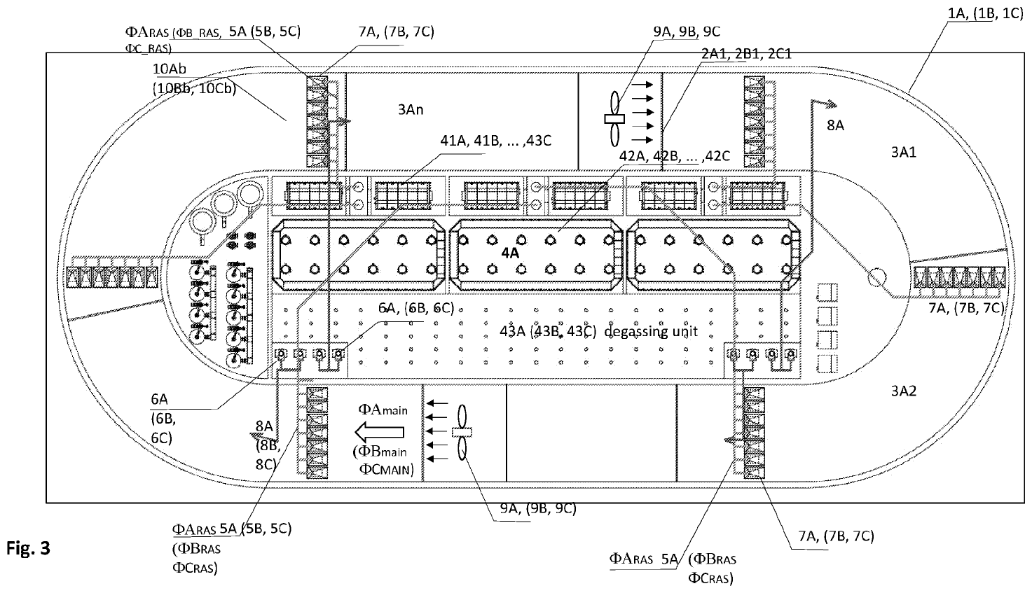

In an embodiment of the invention, wherein the number of water outlets (7A) is two, three or more and the water outlets (7A) are generally arranged in transversal rows. Reference is made to FIG. 3 and FIG. 4.

In an embodiment of the invention, the water outlet (7A) is connected to a transversal channel (71A) where the transversal channel (71A) extends from below the bottom (10Ab) and to within the perimeter of the inner wall (10Ai) and to the filter units (41A).

In an embodiment of the invention, the water return inlet (8A) of the water treatment flow (ΦA_{RAS}) is co-current with the main flow (ΦAmain).

In an embodiment of the invention, the water return inlet (8A) forms an angle of 30 degrees with the bottom (10Ab).

In an embodiment of the invention, the number of water return inlets (8A) is two, three or more, and the water return inlets (8A) are generally arranged in a transversal row.

In an embodiment of the invention, a transversal channel (81A) extends from the pump (6A) and outwards from the bottom (10Ab) to outwards of the inner wall (10Ai) to the water return inlet (8A). Reference is made to FIG. 4.

An advantage of this embodiment is that the transversal channel (81A) may have a low profile which requires less ground and civil work during the construction of the tank unit (A).

In an embodiment of the invention, the water outlet (7B, 7C) for the water treatment flow (ΦB_{RAS}, ΦC_{RAS}) for the water treatment plant (4B, 4C) is arranged in the bottom (10Bb, 10Cb) of the oval flow tank (1B, 1C). The advantage of having the water outlet (7B, 7C) arranged at the bottom (10Bb, 10Cb) of the oval grow-out flow tank (1B, 1C) is that it will drain out the water comprising the precipitated particles flowing along the bottom layers of the water.

In an embodiment of the invention, the water outlet (7B, 7C) of the water treatment flow (ΦB_{RAS}) (ΦC_{RAS}) is co-current with the main flow (ΦBm, ΦCm).

In an embodiment of the invention, the water outlet (7B, 7C) forms an angle of 30 degrees with the bottom (10Bb, 10Cb). The advantage of the above embodiment is that the flow energy loss at the outlet is reduced, which may otherwise result in a reduced turbulence in and around the water outlet (7B, 7C).

In an embodiment of the invention, the water outlet (7B, 7C) leads to a transversal channel (71B, 71C) where the transversal channel (71A) extends from below the bottom (10Bb, 10Cb) and to within the perimeter of the inner wall (10Bi, 10Ci) and to the filter units (41B, 41C), please see FIG. 4. In an embodiment of the invention, the filter units (41B, 41C) are rotating drum filters with continuous flushing and removal of filtered-out particles which are subject to further treatment and drying.

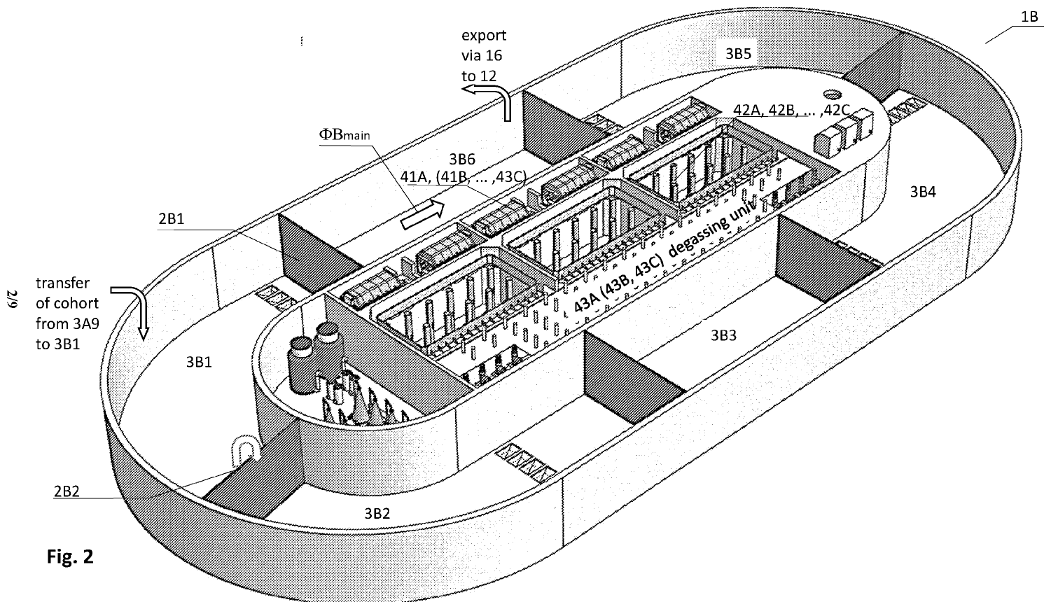

In an embodiment of the invention, the number of water outlets (7B, 7C) is two, three or more, and the water outlets (7B, 7C) are generally arranged in a transversal row across the entire width of the grow-out flow tanks (1B, 1C), reference is made to FIG. 2, FIG. 3 and FIG. 4.

In the embodiment shown in FIG. 3 there are seven water outlets (7A, 7B, 7C) in the transversal row extending across the entire width of both the postsmolt and the grow-out flow tanks (1A, 1B, 1C).

In an embodiment of the invention, the water treatment flow (ΦB_{RAS}) (ΦC_{RAS}) from the second and third water treatment plants (4B, 4C) are pumped back to the oval grow-out flow tanks (1B, 1C), respectively via water return inlets (8B, 8C) arranged through at least one or more of the inner walls (10Bi, 10Ci) or the bottom (10Bb, 10Cb) (see FIG. 4) of the oval grow-out flow tanks (1B, 1C), reference is made to FIG. 2, FIG. 3 and FIG. 4. In an embodiment of the invention, the water return inlet (8B, 8C) forms an angle of 30 degrees with the bottom (10Ab).

In an embodiment of the invention, the number of the water return inlets (8B, 8C) is two, three or more, and the water inlets (7B, 7C) are generally arranged in transverse rows. An advantage of the above water return inlets (8B, 8C) is that they effectively contribute to maintaining the main grow-out water flow (ΦBmain, ΦCmain).

In an embodiment of the invention, a transversal channel (81B, 81C) extends from the pump (6B, 6C) and out below the bottom (106b, 10Cb) and to outside the perimeter of the inner wall (10Bi. 10Ci) and to one or more of the water return inlets (8B, 8C). An advantage of this arrangement is that the transversal channel (81B, 81C) may have a low profile which requires less ground work during the construction of the tank units (B, C).

In an embodiment of the invention, the fourth water treatment plant (16) for the purge unit (12) comprises a fresh water intake line (161) and a discharge line (168) to the second and third water treatment plants (4B, 4C).

In a further embodiment of the invention, the fourth water treatment plant (16) includes a freshwater intake line (161) and a discharge line (169) to the water treatment plant (4A) of the grow-out tank (A). The freshwater intake line (161) may be from a river, a lake, a well, a municipal water utility line, or the sea, or a combination of the above. The main advantage of having a separate freshwater intake line is that all of the incoming water supply to the entire plant may be controlled, filtered and UV-treated in order to prevent contamination from the environment.

In an embodiment of the invention, the water treatment plant (16) comprises filter units (162), a degassing unit with CO2 treatment (163) and ozone treatment unit (164). In an embodiment of the invention, there may be an Oxygen supply (165) to the circuit of the water treatment plant (16) which is automatically controlled, or the Oxygen supply (165) may be directly connected to the purge chambers (13a, 13b, . . . 13z) and also manually controlled in order to enable operation also during an electrical black out.

In an embodiment of the invention, the water level in the purge units (12), the fourth water treatment plant (16) is successively decreasing from the purge chambers (13a, 13b, . . . 13z) to the filter unit (162), to the degassing unit with CO2 treatment (163), further to the UV-treatment unit (166) and to the pumps (167) wherein the pumps (167) pump water back up to a level corresponding to the water level in the purge chambers (13a, 13b, . . . 13z).

In an embodiment of the invention, the water level in the purge chambers (13a, 13b, . . . 13z) is kept at a higher level than in the water flow tanks (1B, 1C). Keeping the water level in the purge chambers at a higher level than in the water flow tanks has two advantages. One advantage is that it is easier to let the fish swim against the current from the last grow-out section (3Bm, 3Cm) via the inlet channel (15) to the purge chambers (13). The second advantage is that we can hinder/prevent contamination from the flow tanks (3B, 3C) to the purge unit (12) in case an outbreak of disease occurs in the considerably larger flow tanks (3B, 3C).

In an embodiment of the invention, transfer lines (11B, 11C) from the postsmolt tank (A), please see FIG. 1, comprise a fish pump (110), a flexible hose (1116, 111C) to a separation grid (112B, 112C) which further leads the fish to the first section (361, 3C1) in each of the grow-out flow tanks (3B, 3C). The separation grid (112B, 112C) will act as a dry spacer and as a barrier between the mentioned tanks. It will be flanged between the last portion of the flexible hose and the inlet of the first section. Using a separation grid (112B, 112C) between the flexible hose and the first section (361, 3C1) may reduce the potential of transferring diseases with the water from the postsmolt tank (A) to the grow-out flow tanks (3B, 3C) as there is little fluid transfer between the tanks, just fish. The drained water from the separation grid (112B, 112C) may be returned to the postsmolt tank (A) or made subject to water treatment and then returned to the postsmolt tank (A) or released to the environment.

In an embodiment of the invention, a fish counting device (113) is provided in the transfer lines (11B, 11C). The fish counting device will ensure that only the planned amount of fish will be transferred from the postsmolt tank (A) to each of the first sections (361, 3C1) in each of the grow-out flow tanks (1B, 1C). If the fish cohort shall only be distributed evenly between the two first sections (361, 3C1), the fish counting device (113) may be used to check the number of fish transferred to each section. The fish counting device (113) can either be placed upstream or downstream said fish pump (110) all depending upon location and required ease of maintenance for the fish counting device (113) and/or fish pump (110).

In an embodiment of the invention, the transverse separation grids (2A1-2An, 2B1-2Bm, 2C1-2Cm) are motorized and movable along their associated flow tanks (1A, 1B, 1C).

In another embodiment of the invention, the separation grids (2A1-2An, 2B1-2Bm, 2C1-2Cm) are movable via a motor (18A1, 1861, 18C1) connected to a vertical shaft (19A1, 1961, 19C1) down to a pinion or gear (20A1, 2061, 20C1) that is in mesh with a rack (21A1, 21131, 21C1) that extends along the bottom (10Ab, 106b, 10Cb) of the oval flow tank (1A, 1B, 1C).

By individually regulating the position of the transverse separation grids (2A1-2An, 2B1-2Bm, 2C1-2Cm) one can control the segment length, i.e. segment volume of each tank, thereby establishing the necessary volume for the actual amount and size range of the fish cohort in question.

In an embodiment of the invention, at least one of the separation grids (2A1-2An, 2B1-2Bm, 2C1-2Cm) comprises a gate (21A1, 21B1, 21C1), where said gate (21A1, 21B1, 21C1) is movable for forced displacement of fish from one section to the other sections (3A1 to 3Am or 3B1 to 36m or 3C1 to 3Cm).

In an embodiment of the invention, the flow generator (9A, 9B, 9C) that provides the main flow (ΦAm, ΦBm, ΦC m) is arranged within the perimeter of the inner wall (10Ai, 10Bi, 10Ci), or outside the perimeter of the outer wall (10Ao, 10Bo, 10Co), or below the bottom (10Ab, 10Bb, 10Cb) in relation to the main flow path in the oval flowtank (1A, 1B, 1C) wherein the grids (2A1-2An), (2B1-2Bm), (2C1-2Cm) are movable to any position within the flow tank (1A, 1B, 1C) so as for moving each cohort gradually towards the outlet for fish from the tank instead of moving the fish across a grid.

The advantage with this configuration is that sections (3A1 to 3An or 3B1 to 3Bm or 3C1 to 3Cm) successively change roles, in such a manner that 3A1 takes the role of 3A2, 3A2 takes the role of 3A3 etc. until when 3A9 is emptied (or discharged) with its dedicated grown cohort, 3A9 continues onward and becomes 3A1, is filled up with a new smolt cohort and repeats the above mentioned sequence. In this way each cohort will stay in a dedicated section and grow from 100 grams to 1900 grams during the rotational sequence in each tank (A, B, C). During this growth sequence each grid (2A1-2An), (2B1-2Bm), (2C1-2Cm) are movable to any position within the flow tank (1A, 1B, 1C) to allow for the cohort growth rate.

Component List

| Component | Description |
|---|---|
| A, B, C | Postsmolt unit, Grow-out units |
| ΦAMAIN, ΦBMAIN, | Main flow A, B, C in oval flow tanks, postsmolt |
| Φ CMAIN | and grow-out tanks |
| ΦARAS, ΦBRAS, | Flow through water treatment plant 4A, 4B, 4C |
| Φ CRAS | first, second, third |
| 1A, 1B, 1C | Oval flow tanks, 1A postsmolt flow tank, 1B, |
| | 1C grow-out flow tanks |
| 2A1-2An | Transverse separation grids no. 1 to n |
| 3A1-3An | Tank sections of postsmolt unit |
| 2B1-2Bm | Transverse separation grids no. 1 to m |
| 3B1-3Bm | Tank sections of grow-out unit |
| 2C1-2Cm | Transverse separation grids no. 1 to m |
| 3C1-3Cm | Tank sections of grow-out unit |
| 4A, 4B, 4C | Water treatment plants first, second and third |
| 5 | SPARE |
| 6A, 6B, 6C | Pumps in water treatment plants |
| 7A, 7B, 7C | Water outlets from oval flow tanks to first, |
| | second and third water treatment plants, resp. |
| 8A, 8B, 8C | Water return inlets from water treatment plants |
| | to oval flow tanks |
| 9A, 9B, 9C | Main flow generators for flow tanks, postsmolt |
| | flow tank and grow-out flow tanks |
| 10Ai, 10Bi, 10Ci | Inner walls of flow tanks |
| 10Ab, 10Bb, 10Cb | Bottom of flow tanks |
| 10Ao, 10Bo, 10Co | Outer walls of flow tanks |
| 11B, 11C | Transfer line from postsmolt chamber 3An to |
| | grow-out chamber 3B1, 3C1 |
| 12 | Purge unit after grow-out chamber 3Bm and |
| | 3Cm |
| 13 | Purge chamber 1 to 8 in purge unit |
| 14B, 14C | Lock gates from grow-out chamber 3Bm and |
| | 3Cm to inlet channel 15 |
| 15 | Inlet channel to purge unit |
| 16 | Fourth water treatment plant for purge unit |
| | and for fresh intake water line 161 |
| 17 | Slaughter house |
| 18A1, 18B1, 18C1 | Motor |
| 19A1, 19B1, 19C1 | Vertical shaft |
| 20A1, 20B1, 20C1 | Pinion |
| 21A, 21B, 21C | Rack |
| 22A1, 22B1, 22C1 | Gate |
| 41A, 41B, 41C | Filter unit, drum filter |
| 42A, 42B, 42C | Biofilm reactor |
| 43A, 43B, 43C | Degassing unit with CO2 treatment |
| 44A, 44B, 44C | Ozone treatment unit |
| 45A, 45B, 45C | Oxygen supply |
| 71A, 71B, 71C | Transversal channel |
| 81A, 81B, 81C | Transversal channel |
| 91Ao, 91Bo, 91Co | Main flow outlet to external flow generators |
| 91Ai, 91Bi, 91Ci | Return inlet |
| 92A, 92C, 92C | Main flow generator tunnel |
| 97A, 97B, 97C | Grid for main flow generator tunnel |
| 110 | Fish pump |
| 111B, 111C | Flexible hose |
| 112B, 112C | Separation grid |
| 113 | Fish counting device |
| 161 | Fresh water intake line |
| 162 | Filter units |
| 163 | Degassing unit with CO2 treatment |
| 164 | Ozon water treatment unit |
| 165 | Oxygen supply |
| 168 | Discharge line to water treatment plant |
| 169 | Discharge line to water treatment plant |
| 171 | Export line |

1-54. (canceled)

55. A land-based fish rearing plant comprising:
a postsmolt unit comprising:
an oval postsmolt flow tank for postsmolt, subdivided by a number of transverse separation grids into tank sections for postsmolt cohorts of successively increasing sizes, with a first uninterrupted main water flow along a main flow path in said oval postsmolt flow tank, said main water flow generated by one or more main flow generators; and
one or more water outlets for a partial water flow from the oval postsmolt flow tank, directly to a water treatment flow in a first water treatment plant, wherein said water treatment plant is arranged within a perimeter constituted by an inner wall of said flow tank, and wherein said first water treatment plant comprises a piping arrangement and pumps and one or more water return inlets directly back to said flow tank;
two grow-out units for growing salmon in stages after postsmolt stages, each grow-out unit comprising:
an oval growth flow tank subdivided by a number of transverse separation grids into tank sections for growing salmon cohorts of successively increasing sizes;
one or more main flow generators for providing a second and third uninterrupted main water flow, respectively, along a main flow path in said oval flow tank, said second and third main water flows generated by one or more main flow generators, respectively; and
water outlets for a second and third water treatment flow, respectively, to a second and third water treatment plant comprising piping arrangements and pumps and one or more water return inlets, respectively, wherein said water treatment plants are in their entirety arranged within the perimeters of the inner walls of said flow tanks, respectively;
one or more transfer lines for a largest postsmolt-cohort from a final section in the postsmolt flow tank over to a first section of each of the growth tanks, respectively; and
a purge-unit, arranged between said two grow-out units, wherein the largest cohort sections in said grow-out flow tanks, respectively, are connected via lock gates, respectively, to an inlet channel to two or more purge chambers for temporary holding and purging of slaughter-ready salmon, wherein the purge-unit comprises at least a water treatment plant and an export line to a fish slaughterhouse.

56. The land-based fish rearing plant according to claim 55, wherein the number of said transverse separation grids and tank sections is between 6 and 10.

57. The fish rearing plant according to claim 55,
wherein said postsmolt flow tank is arranged for post smolt weighs 100-1900 grams, and
wherein said grow-out unit's flow tanks are arranged for holding grow-out salmon in the size range 1900-4300 g.

58. The fish rearing plant of claim 55, wherein said water treatment plant comprises filter units, a biofilm reactor, a degassing unit with CO2 removal, and an Ozone treatment unit, and wherein said water treatment plants comprise filtering units, a biofilm reactor, a degassing unit with CO2-removal, and an Ozone treatment unit.

59. The fish rearing plant claim 56, wherein the number of separation grids in said grow-out units oval flow tanks is between 3 and 7.

60. The fish rearing plant according to claim 57,
wherein said first main flow generator for providing said first main water flow is arranged outside the perimeter of said outer wall relative to the first main water flow path in said oval postsmolt flow tank,
wherein said flow generator for providing said main water flow is arranged within a first tunnel outside a perimeter of said outer wall relative to the first main water flow path in said oval postsmolt flow tank,
wherein said first tunnel comprises a first flow outlet with a first grid and a first water return inlet back to the oval postsmolt flow tank,
wherein said second main water flow generators for providing said second and third main water flows in said oval grow-out flow tanks are arranged outside a circumference of the outer wall relative to the second and third main flow paths of the second and third oval flow tanks,
wherein said second and third flow generators for providing said second and third main water flows are arranged within second and third tunnels which are outside the perimeters of said outer walls, respectively, relative to the main flow paths in said second and third, oval flow tanks, and
wherein said tunnels comprise main flow outlets with grids, and water return outlets back to the oval flow tanks, respectively.

61. The fish rearing plant according to claim 60, wherein the number of said purge chambers is between four and ten.

62. The fish rearing plant according to claim 58,
wherein a water level in said postsmolt unit decreases successively from the oval flow tank to said filter unit, to said biofilm reactor and further to said degassing unit with CO2 treatment, and
wherein the water level in said oval grow-out flow tanks decreases successively from the oval flow tanks to said filter units, to said biofilm reactor and further to said degassing unit with CO2 treatment.

63. The fish rearing plant according to claim 62,
wherein a water outlet for said water treatment flow to said water treatment plant is arranged in the bottom of said oval flow tank,
wherein said water treatment flow from said water treatment plant is pumped back to said oval postsmolt flow tank via a water return inlet that is arranged through at least one or more of said inner walls, or said bottom of said oval postsmolt flow tank,
wherein said water inlet of said water treatment flow is co-current with said main flow, and
wherein said water outlet forms an angle of 30 degrees with said bottom.

64. The fish rearing plant according to claim 63, wherein the number of said water inlets is two or more and said water inlets are generally arranged in transversal rows, and
wherein said water outlet is connected to a transversal channel which extends from below said bottom and to within the perimeter of said inner wall and to said filter units,
wherein said water return inlet of said water treatment flow is co-current with said main flow,
wherein said water return inlet forms an angle of 30 degrees with said bottom,
wherein the number of said water return inlets is two or more, and said water return inlets are generally arranged in transversal rows, and
wherein a transversal channel extends from said pump and outwardly below said bottom to outside of said inner wall to said water return inlets.

65. The fish rearing plant according to claim 64,
wherein said water outlets for said water treatment flow for said water treatment plant are arranged in said bottoms of said oval grow-out flow tanks, respectively,
wherein water outlets of said water treatment flow are co-current with said main flows, respectively,
wherein said water outlets form angles of 30 degrees with said bottoms, respectively,
wherein said water outlets lead to transversal channels extending from below said bottoms and to within the perimeters of said inner wall and to said filtering units, respectively,
wherein the number of said water outlets is two or more, and are generally arranged in transversal rows extending across the widths of the flow tanks,
wherein said water treatment flows from said water treatment plants are pumped back to said oval flow tanks via water return inlets, respectively, arranged through said inner walls, or said bottom of said oval flow tank,
wherein said water return inlets form angles of 30 degrees with said bottoms, respectively,
wherein the number of said water return inlets are two or more, and said water inlets are generally arranged in transversal rows, and
wherein transversal channels extends from said pumps and out below said bottom and to outside the perimeters of said inner wall to the one or more water return inlets, respectively.

66. The fish rearing plant according to claim 62, wherein said water treatment plant for said purge unit further comprises
a fresh water intake line and a discharge line to each of said water treatment plants of said grow-out units,
wherein said purge unit water treatment plant includes a freshwater intake line and a discharge line to said water treatment plant of said grow-out tank, and
wherein said purge tank water treatment plant comprises filtering units, a degassing unit with CO2 removal and an ozone treatment unit.

67. The fish rearing plant according to claim 66,
wherein the water level in said purge unit's water treatment plant is successively decreasing from said purge chambers to said filter unit, to said degassing unit with CO2 removal, further to said UV-treatment unit and to said pumps which pump water up corresponding to said water level in said purge chambers, and
wherein a water level in said purge chambers is kept at a higher level than in said grow-out flow tanks.

68. The fish rearing plant according to claim 62, further comprising wherein transfer lines from said postsmolt tank comprise a fish pump, a flexible hose to a separation grid further leading the fish to said first section in each of said flow tanks.

69. The fish rearing plant according to claim 55, wherein said transverse separation grids movable along their associated flow tanks, and
further comprising motors arranged for moving said separation grids, said motors connected to vertical shafts down to pinions that mesh with racks that extend along the bottoms of the oval flow tanks, respectively.

70. The fish rearing plant according to claim 69,
wherein at least one of said separation grids comprises a gate, where said gate is movable for crowding of fish from one section to the other sections.

71. The fish rearing plant according to claim 69, wherein said flow generators providing said main water flows along the main water flow path, are arranged outside the outer perimeters of said outer walls, respectively, relative to the main flow paths in said oval flowtank, wherein said grids are movable to any position within the flow tanks, respectively, so as for moving each cohort gradually towards the outlets for fish from the tanks/inlet channels to purge chambers.

72. A method for fish farming in a fish rearing plant according to claim 55, comprising:
running said flow generators and said pumps;
having said sections occupied with postsmolt and said sections occupied with grow-out salmon;
at given time intervals:
for said grow-out flow tanks:
transferring a largest cohort of grow-out salmon alternately from one section to said inlet channel to one of said purge chambers for temporary holding and purging of the salmon,
for each tank section prior to said tank section all the way down to said first section, moving each said grow-out salmon cohort to a next tank section,
for said postsmolt-tank and said grow-out flow tanks:
transferring a largest cohort of postsmolt over from the last section over to said first sections in said grow-out flow tanks,
for the postsmolt-tank:
for each tank section prior to section all the way down to said first section, moving each postsmolt cohort to a subsequent tank section,
supplying a new postsmolt cohort to said first tank section of said postsmolt tank, and
transferring salmon from the purge chamber to an export line to a fish slaughter house.

73. The method according to claim 72, comprising transferring a largest cohort of postsmolt from the last section evenly distributed to both first said sections of said flow tanks, simultaneously.

74. The method according to claim 72, comprising regulating the temperature in the flow tanks to different temperatures in such a way that said cohort in said last section achieves its slaughtering weight at different/staggered time intervals, at the interval in-between inserting and transferring of cohorts in the postsmolt tank.

75. The method according to claim 72,
wherein said separation grids are moved within said flow tanks for adjusting a length of said tank sections in order to better adjust their volume to the size of the growing cohorts.

76. The method according to claim 72, wherein said flow generators providing said main flow are arranged outside the perimeters of said outer walls, of said oval flowtank and wherein said grids are movable to any position within the flow tank, moving each cohort gradually towards the outlet for fish from the tanks.
